(19) United States
(12) Patent Application Publication
(10) Pub. No.: US 2010/0233032 A1
(43) Pub. Date: Sep. 16, 2010

(54) Cartridge For A Fluid Sample Analyser

(76) Inventors: Mark John Frogley, Huntingdon (GB); Christopher John Hammond, Cambridgeshire (GB); Stuart Moore, Cambridge (GB); Klaus Whieler, Hamburg (DE)

Correspondence Address: FOLEY HOAG, LLP (w/ISA);PATENT GROUP, 155 SEAPORT BLVD., BOSTON, MA, 02210-2600, US

(21) Appl. No.: 12/443,106

(22) PCT Filed: Sep. 26, 2007
(86) PCT No.: PCT/GB07/03659

§ 371 Date: Apr. 13, 2010

(30) Foreign Application Priority Data
Sep. 27, 2006 (GB) 0619008.6

(51) Int. Cl. G01N 27/00

(52) U.S. Cl. 422/82.01

(57) ABSTRACT

A cartridge is used in apparatus for analysing a sample comprising a fluid and has a sample receiving cell which receives the fluid for analysis. The cell comprises a surface on one of two housing parts (120; 200; 300; 102; 202; 302) and a sensor comprising an electrical-mechanical transducer (92; 240; 340) spaced from said surface. The sensor is attached to one of the housing parts by an adhesive membrane (100; 246; 346) wherein the membrane is attached only to one of said parts of housing so that any slight relative movement or flexing of the housing parts does not result in forces being applied to the sensor via the membrane.

### FIELD OF THE INVENTION

This invention relates to a cartridge for apparatus for analysing a sample comprising a fluid, and in particular to a cartridge having a sensor, for performing that analysis, comprising an electrical-mechanical transducer.

### BACKGROUND TO THE INVENTION

The invention is applicable to apparatus in which a transducer modifies an applied electrical signal, in particular to apparatus, for example a quartz crystal microbalance system, having a piezoelectric transducer which vibrates at a frequency at or close to its resonant frequency.

The transducer typically has an active surface on which a receptor group is immobilised. That group has a chemical affinity or reactivity towards the substance to be detected or analysed. The substance to be analysed is normally present in a fluid which is brought into contact with the active surface of crystal.

Physical, chemical and biochemical interactions between the receptor group on the surface and the substance cause a change in the mass attached to the surface (and in other physical properties of the active surface), and these affect the vibrational characteristics, in particular the resonant frequency, of the crystal. Analysis of these effects can be used to obtain qualitative and/or quantitative data on the substance.

In some types of known apparatus, the quartz crystal sensor is formed as part of a flow cell which is connected to a sample delivery/removal system for passing a sample to be analysed through the cells so that the sample comes into contact with the crystal. The apparatus will include drive measurement circuitry, which is connected to the crystal, and which is operable to vibrate the crystal and to detect and/or measure the changes in the crystal's vibrational characteristics.

Replacement of the transducer is frequently necessary, particularly in the field of bio-sensors, if a number of different substances in a fluid sample are to be analysed or if the receptor coating on the crystal cannot be used more than once.

In that connection, it is known to provide the crystal and the flow cell in a single cartridge which may be readily inserted into and removed from apparatus providing the electrical circuitry and the sample delivery/removal system. An easily manufactured flow cell which is disposable, yet easily and robustly mountable into the measurement apparatus is therefore highly desirable.

U.S. Pat. No. 6,196,059 shows a cartridge formed from an injection moulded component having an annular rib to which the crystal is adhered. The rib spaces the crystal from an opposed face to define a flow cell, and the injection moulded component also includes recesses for contacts at a position spaced from the crystal. The contacts are connected to the crystal by electrical wires, and provide a means of connection between the crystal and the appropriate drive/measurement circuitry.

Such a cartridge is of a relatively complex construction and is therefore relatively expensive, especially since the cartridge is to be used as a disposable unit. In addition, the minimum distance between the crystal and the underlying surface, and hence the volume of the flow cell, is limited by the rib, which provides a lower limit on the height of the flow cell. This can prevent the flow cell from achieving rapid immobilisation times, and this correspondingly limits the speed of response of the apparatus and the kinetic parameters that can be measured. Additionally the cartridge requires a manual electrical connection operation between the terminal of the transducer and the instrument, which is inconvenient in operation.

In the analysis of biomechanical interactions, available volumes of analyte fluid are frequently limited, so the volume of the flow cell should be small. It is also known that measurements of kinetic properties of analyte receptor interactions can be limited by the diffusion of analyte to the surface of the transducer. In order to minimise this transport limitation, and preferably overcome it, the dimension of the flow cell in the direction perpendicular to the transducer surface should be minimised.

The mounting of electromechanical piezo-electrical transducers such as quartz crystal oscillators in such a way that the mounted transducer is free of residual stress, and forms a reliable fluid tight seal is an important design objective of such cells. WO2128372 and WO0247246 propose various means intended to achieve stress free mounting, but in these cases there results a relatively complex multipart design for fabricating a leak tight structure, and further, as with U.S. Pat. No. 6,196,059 above this results in a situation where it is difficult to obtain a low volume of the flow cell.

### SUMMARY OF THE INVENTION

According to the invention, there is provided a cartridge for apparatus for analysing a sample comprising a fluid, the cartridge comprising a housing having at least two parts and a sample receiving cell comprising a surface on one of said parts, a sensor comprising an electrical-mechanical transducer spaced from said surface, and an adhesive membrane attaching the sensor to one of the housing parts, wherein the membrane is attached only to one of said parts of the housing.

PCT Patent Application No. PCT/GB2006/001162 shows a cartridge in which a flow cell has a two-part housing and a sensor, such as a piezoelectric element, attached to one of the housing parts through an adhesive membrane. It is to be noted that as of the priority date of the present application, PCT Patent Application has yet to be published.

The use of a combination of a membrane and an adhesive between the sensor and the relevant housing part enables the flow cell to be formed from relatively simple components and hence to be relatively cheap. However, the adhesive membrane also forms part of the means for joining together the two housing parts, as a result of which any relative shear forces applied to the two housing parts can be transmitted via the membrane to the sensor. It has been found that such forces can arise when the cartridge is inserted into a docking mechanism, as a result of natural tolerances in the docking mechanism and the assembly of the cartridge. When the cartridge is assembled, there will be a natural variation in skew between the base and top plates due to tolerances in alignment during assembly of the two parts. Similarly, there will be a small amount of misalignment between the parts of the docking mechanism that locate the top and bottom halves of the cartridge.

Slight differences in the relative positions of the housing parts might lead to different characteristics of the sensors from one cassette to another. In addition, relaxation of the adhesive on the membrane over time may cause a residual drift in the characteristics (especially the unloaded resonance frequency) of the sensor over time.

In the present invention, however, the two housing parts are not coupled by the adhesive membrane to which the sensor is attached so that any shear forces applied to those two parts are not transmitted by the membrane to the sensor.

Preferably, the surface of the housing defining part of the cell is on the housing part to which the sensor is attached, the surface being spaced from the sensor by said membrane.

Preferably, the other housing part includes a recess in which the cell is situated.

Preferably, the recess surrounds the cell.

Thus said other housing part also surrounds the recess and can therefore reduce or eliminate flexing of the cartridge as it is inserted into the docking mechanism.

The recess and surface may conveniently define a cavity in which the membrane is wholly contained.

Preferably the housing parts contact each other in such a way that the other housing part provides one or more surfaces which support the housing part defining part of the cell, and extend in opposite directions along one axis from two opposing sides of the cavity, in such a way that the housing part defining part of the cell forms a fully supported beam in engineering terms.

When the two parts are contacted in this way, the contacting surface or surfaces are held together across the entire contact area, as if rigidly connected, so that the surface or surfaces cannot move apart at any point. In the presence of bending forces applied perpendicular to the surfaces this reduces the flexural strain of the housing part defining part of the cell in the areas which are not supported and hence the bending stress on the transducer, to which it is attached. By this means stress on the crystal is reduced when the cartridge is inserted into the docking station.

More preferably surface or surfaces of said other housing part, which surface or surfaces support the housing part defining part of the cell, also extend in opposite directions along a second axis from two further opposing sides of the cavity in order to further reduce flexing of the housing part to which the sensor is attached perpendicular to the supporting surface or surfaces, and the recess is rectangular

Preferably, the housing parts engage each other in such a way as to locate the housing parts relative to each other so as to prevent relative movement of the parts along a first axis.

Preferably said engagement also prevents relative movement of the two housing parts along a second axis perpendicular to the first axis.

To that end, the housing parts may interlock with each other.

Additionally or alternatively one of the housing parts may be attached to the other.

Preferably the housing parts are bonded together at areas spaced from the membrane.

Preferably the housing parts are bonded together by means of an adhesive.

The adhesive may to advantage be rigid.

This further reduces any tendency for the cartridge to flex as it is inserted into a docking mechanism.

Preferably, the housing part to which the sensor is attached is rigid, preferably having a Young's modulus of not less than 94 GPa.

Each housing part may to advantage comprise a respective plate.

This gives rise to a construction of cartridge which is relatively simple, compact and easy to handle.

The housing part, having the surface constituting part of the cell, preferably comprises a plate and is an insert for a recess in the other housing part, said insert conveniently being more rigid than said other housing part.

This further reduces the likelihood of flexing of the cartridge as discussed above.

Preferably, the cell is a flow cell and has a fluid inlet and a fluid outlet formed as apertures in the insert.

Since the insert can be formed of a rigid material, the apertures may be formed, for example, by drilling at precisely defined locations, relative to the cell, which are not prone to alteration during or as a result of the use of the cartridge.

The insert may to advantage be of a cruciform shape.

Such a shape enables fluid inlets/outlets to be accommodated, along with fixing points for attachments to said other housing part, in a relatively small area Consequently, the cartridge can have a relatively small insert. This facilitates construction of the cartridge particularly if the insert is made of a material which (by virtue of its rigidity or frangibility etc) cannot as easily be formed into the desired shape as the other housing part.

Preferably, the sensor comprises a piezoelectric element. The piezoelectric element may be a transverse shear mode resonator for example an AT cut quartz crystal. The quartz crystal may comprise one or more sensing areas defined by the electrode patterns. The sensing areas may be individually associated with a flow cell by means of a single adhesive membrane having multiple cut out regions, where each cut out region defines a respective cell for providing sample to a respective sensing area of the crystal, and where each cell has an associated inlet and outlet. The other housing part may be provided with multiple recesses each to locate a housing part to which one or more individual sensors and cells are attached.

The cartridge may include one or more drainage conduits, such as channels or gullies in one of the housing parts, for any leak of fluid from the cell.

### BRIEF DESCRIPTION OF THE DRAWINGS

The invention will now be described, by way of example only, with reference to the accompanying drawings, in which:

FIG. 1 is an exploded perspective view of a cartridge (not in accordance with the invention) described in PCT Patent Application No. PCT/GB2006/001162;

FIG. 2 is a sectional side view of the cartridge; and

FIG. 3 is a cross-sectional view along the line XII-XII of FIG. 2;

FIG. 4 is a view, corresponding to FIG. 2, of a cartridge in accordance with the invention;

FIG. 5 is an exploded perspective view, corresponding to FIG. 1, of a second embodiment of cartridge in accordance with the invention;

FIG. 6 is an exploded perspective view of a third embodiment of cartridge in accordance with the invention, the angle of the view being such as to show the upper surface of the cartridge;

FIG. 7 is an exploded perspective view of the third embodiment from an angle from which the underside of the cartridge is shown;

FIG. 8 is a cross sectional view of the cartridge shown in FIGS. 6 and 7;

FIG. 9 is a sectional view of part of the cartridge to an enlarged plane, the section being taken in the same plane as that of FIG. 8;

FIG. 10 is a sectional view, in the same plane as FIGS. 8 and 9, of a modified version of the cartridge;

FIG. 11 is a view, corresponding to FIG. 10, of a second modified version of the cartridge;

FIG. 14 is an exploded isometric view, corresponding to FIG. 7, of a fourth embodiment of cartridge in accordance with the invention.

### DETAILED DESCRIPTION

The cartridges shown in the drawings are for use as part of a quartz crystal microbalance apparatus, which includes a docking station for connecting each of two flow cells in the cartridge to a fluid delivery/removal system and for connecting a transducer in the form of a quartz crystal plate 92 to electrical circuitry for vibrating the crystal and measuring the crystal's vibrational characteristics. Such apparatus is described in the present applicant's co-pending UK patent application number 0506711.1

Since the first embodiment is similar in many respects to the cartridge shown in PCT/GB2006/001162, the latter will first be described.

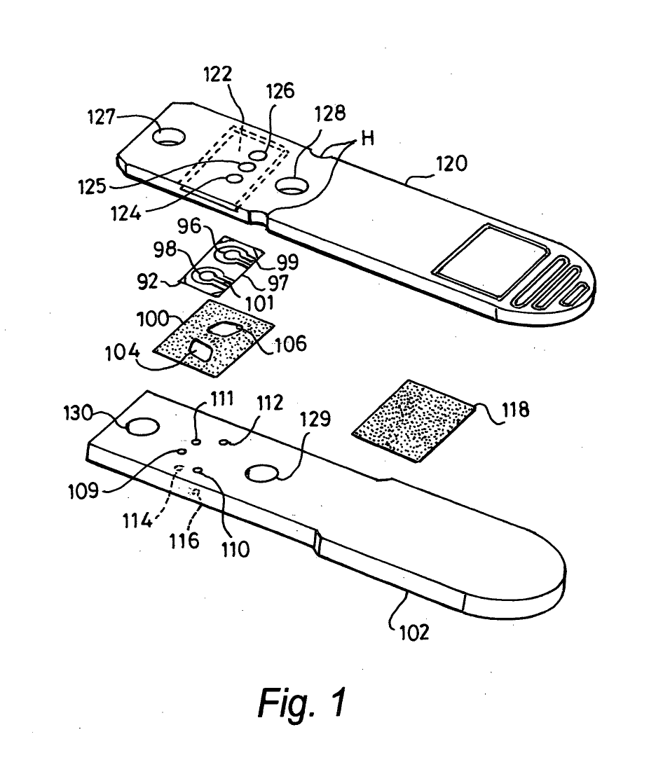

With reference to FIG. 1, the quartz crystal plate is denoted by reference numeral 92, and forms part of the cartridge shown in the drawings. The plate is coated on one surface with gold in a pattern that defines a pair of drive electrodes 96 and 98, each of which is in registry with a respective one of two separate flow cells. The underside of the plate is also coated with gold to form a common earth electrode. A conductive track (not shown) runs from this electrode around the edge of the plate to the top surface of the plate to provide a contact for enabling a coda pin engaging the top surface of the plate to connect to the earth electrode.

The transducer 92 is adhered to the top surface of an adhesive membrane 100 the underside of which is adhered to a plate 102. The upper surface of plate 102 constitutes a support surface for the transducer 92.

The membrane 100 is a three layered structure of a total thickness of 85 microns, and comprising a polyester film carrier layer of 12 microns thickness sandwiched between two adhesive layers, each of a thickness of approximately 36.5 microns. An example of suitable material for the membrane is the double sided adhesive tape sold under the trademark FASTOUCH. The membrane 100 has two generally diamond shaped apertures 104 and 106.

Each of the apertures 104 and 106 is in register with a respective electrode 98 and 96, and thus with an active area of the quartz crystal. The membrane 100 spaces the transducer 92 from the upper surface of the plate 102 so that there is a small gap between each of two said active areas of the quartz crystal and the upper surface of the plate 102, each gap being bounded by the edge of a respective one of the two apertures 104 and 106. Each gap constitutes a respective flow cell which communicates with a respective pair of inlet/outlet passages 109-112 in the plate 102. Each passage leads into a female connector, such as the connectors 114 and 116, which is generally cylindrical and has a tapered end portion, each of the connectors being arranged to receive a respective ferrule of the fluid delivery/removal system of the apparatus. Alternatively the ferrule connectors may also be pre-fitted into the apertures of the cartridge, and arranged to fit into female connectors provided of the fluid delivery/removal system. In a further alternative the ferrules can be co-moulded with the part 102, either in the same material or a more elastomeric material to provide good sealing properties.

It has been found that the inclusion of the ferrules on the cartridge lends to less wear of the fluidic connectors of fluid delivery/removal system over the course of multiple dockings (with successive cartridges).

As can be seen from FIG. 1, the inlet and outlet for each flow cell are located at opposite end regions of the latter. Consequently, a sample introduced into the inlet of the flow cell will flow along the length of the flow cell to the outlet, during which period the sample will interact with the active surface of the crystal and the effect of that interaction will be measured.

As can be seen from FIG. 1, the flow cells are situated towards one end of plate 102, towards the other end of which there is provided a patch 118 of the same material as the membrane 100. The purpose of this patch is to help to adhere a top plate 120 to the bottom plate 102. The top plate 120 includes a recess 122 which, in the assembled cartridge, accommodates and surrounds the sensor 92 so that the latter makes no contact with the plate 120. The membrane 100, however, does extend beyond the boundaries of the recess 122 so as to adhere the two plates 102 and 120 together at their forward ends.

As well as securing the transducer 92 in position and defining each flow cell, the membrane 100 provides a suitable seal, by virtue of the adhesive layers, for preventing fluid escaping from the flow cells.

The upper plate 120 includes through bores 124, 125 and 126 through which, in use, corresponding coda pins of the docking station extend to make respective contact with the electrodes 96 and 98 and the earth contact of the transducer 92. Notches H in the upper plate serve to provide an initial location of the cartridge in the docking mechanism.

The two plates 102 and 120 also include large diameter through bores 127-130, the bore 127 in the plate 120 being in line with the bore 130 in plate 102, the bore 128 with the bore 129 so that there are two large bore through passages in the cartridge housing (defined by the plates 102 and 120). These passages, in use, accept lateral location pins (not shown) of the docking mechanism for assisting in the correct location of the cartridge. These pins also form a part of a Faraday cage surrounding the transducer and connection pins, when the cartridge is engaged by the docking station.

After a cartridge has been inserted into the docking mechanism, the ferrules on the fluidic manifold of the docking station's fluid delivery/removal system are pressed into the female fluid connectors 114, 116, and also corresponding connectors for the second flow cell 105 (not shown) in the bottom plate of the cartridge with sufficient force to cause the ferrules to deform and thereby create a fluid seal.

Then each of the coda pins is extended into a respective aperture 124, 125 and 126 of the cartridge upper plate 120 to engage the drive electrode or, as the case may be the earth contact on the transducer.

The plates 102 and 120 are of an engineering plastics material which is inert to biological materials. Acrylic polymers such as Polymethyl methcrylate (PMMA) amongst many known in the art are suitable.

Optionally the polymer may be coated with a material which resists fouling by biological material.

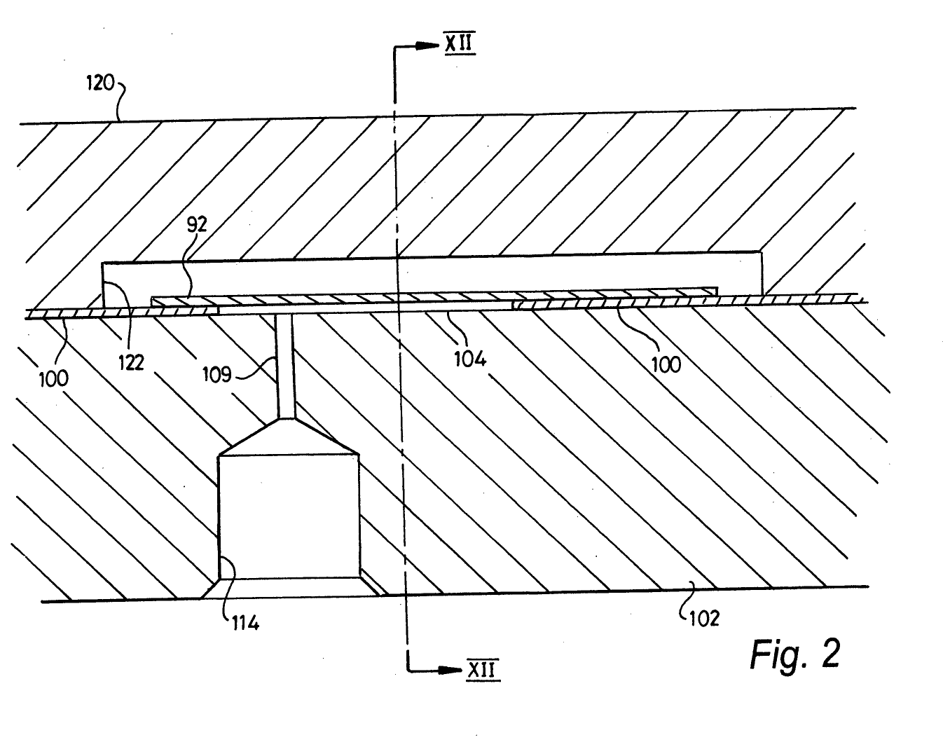

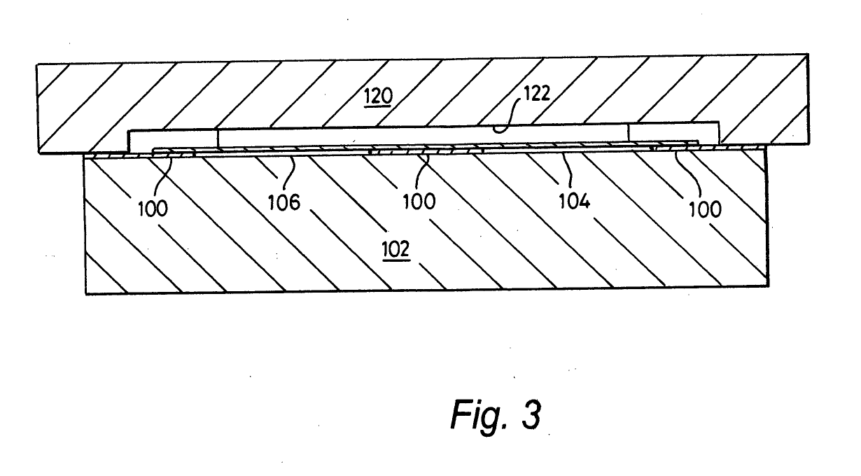

The embodiment of sensor (shown in FIGS. 1-3) has a dual channel sensing plate 92 of quartz which carries an active gold layer on either side. The biochemically active side of the sensor is coated with a continuous coating of gold and is connected to earth. the electrically driven side has a pattern in which the active areas (96 and 98) are circular, with contiguous rectangular areas 99 and 101 extending to the edge of the quartz plate. These rectangular areas provide four electrical contacts between the active electrodes and the Coda pins in the docking mechanism. The electrically active side (i.e. the side carrying the circular electrodes) is also provided with a “guard” earth electrode 97 which forms a respective ring around each driven circular area and serves to dampen any electrical cross-talk between the two or more resonators.

In use, the electrical drive applied to the circular electrodes (through the rectangular areas) causes the quartz plate to resonate. This resonance occurs where the electrically driven electrode opposes the ground plane electrode. Conventionally, this causes a transverse shear mechanical mode to be set up under the circular areas of the driven electrodes.

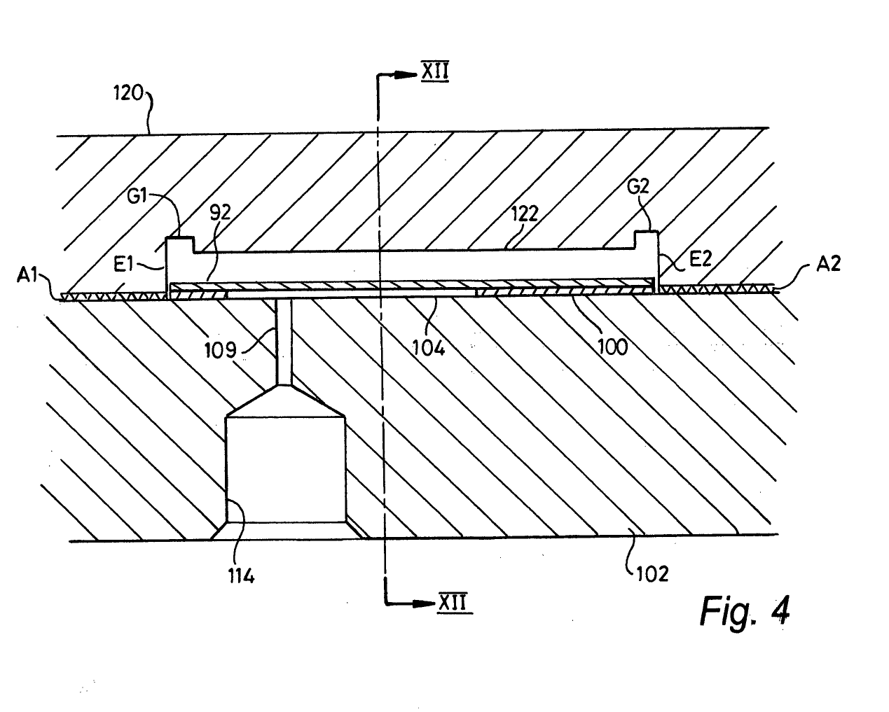

The first embodiment of cartridge in accordance with the invention differs from the cartridge shown in FIG. 1-3 in two respects, but is otherwise identical to that cartridge. Accordingly, the reference numerals of FIG. 1-3 have been adopted in FIG. 4. The first feature of difference relates to the dimensions of the membrane 100. The membrane, as with the case in the cartridge of FIGS. 1-3, is rectangular in its periphery, the longer sides of the rectangle extending across the cartridge from one side to the other, whilst the shorter edges extend front to rear.

The length and the width of the periphery of the membrane are shorter than the length and width, respectively, of the recess 122. As can be seen from FIG. 4, the front and rear edges of the membrane 100 are situated within the recess 122, and are spaced from the front and rear edges (respectively E1 and E2) of the recess 122. Similarly, the short edges of the rectangular membrane 100 also lie within the recess 122, and are spaced from the respective edges of that recess at either side of the cartridge. All four sides of the membrane 100 run parallel with the corresponding sides of the recess 122, the membrane 100 being wholly contained within and surrounded by the edges of the recess 122.

Accordingly the adhesive membrane 100 no longer joins the upper and lower plates (120 and 102) together. Instead, those plates are held together by means of the patch 118 and two further adhesive patches A1 and A2, both of which are spaced from the membrane 100. The patch A1 is rectangular patch extending substantially across the width of the cartridge, and having a rear edge aligned with the leading edge of the recess 122. The patch A2 is an optional feature, and also extends across the width of the cartridge on the opposite side of the recess 122 from the patch A1. The leading edge of the patch A2 is aligned with the trailing edge of the recess 122.

As an alternative to the patches 118, A1 and A2, a hard adhesive may be used to bond the top and bottom parts of the cartridge. Such an adhesive may surround the recess 122 on all four sides and cover all of the joining surfaces of the plates 120 and 102. This increases the rigidity of the cartridge further, thus reducing the bending strain that may result from the insertion of the cartridge into the docking station. The hard adhesive may, for example, be a curing (cross linking) acrylic resin, for example a light cured resin. Such resins may be accurately placed on small scale structures using computer controlled glue applicators on robotic platforms. The cartridge may then be assembled by pick and place instruments, and the adhesive cured in situ. Alternatively the parts may be bonded by laser welding.

The second feature of difference as between the first embodiment and the cartridge shown in FIGS. 1-3 concerns the shape of the recess 122. As can be seen from FIG. 4, the recess includes two opposed channels G1 and G2 which are parallel to each other and run across the entire width of the plate 120, each channel thus also defining two opposed outlet ports in the sides of the plate 122.

If, for any reason, the seal for the flow cells, provided by the membrane 100, allows some leakage of liquid into the recess 122, the channels G1 and G2 provide an escape route for this liquid and can thus prevent the liquid being displaced from the recess 122 through the apertures 124, 125 or 126 as the coda pins are inserted, and thus helps to prevent liquid which has leaked from the cells from reaching, and possibly damaging, the electronic circuitry of the docking station.

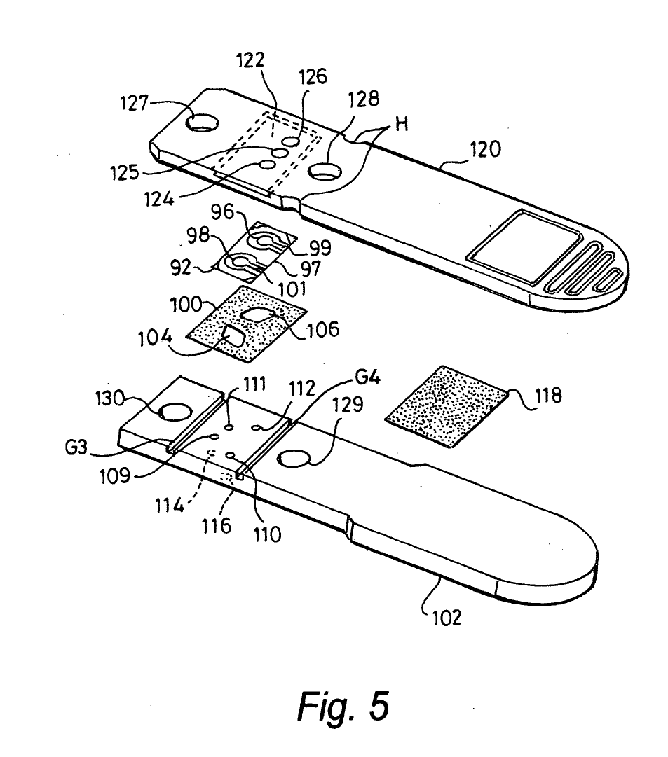

The embodiment shown in FIG. 5 is identical in many respects to that shown in FIG. 4, and the reference numerals of the previous figures have therefore been retained for the FIG. 5 embodiment. In this case, however, the plates 102 and 120 are held together by means of the membrane patch 118. Further patches may be provided at positions corresponding to those of patches A1 and A2 in FIG. 4. Another difference is that, instead of having two drainage channels G1 and G2 in the top plate 120, the cartridge has drainage channels G3 and G4 in the bottom plate 102. The drainage channels run across the entire width of the plate 102, and pass under the recess 122 so as to be able to receive any liquid which has leaked from the flow cells. Such liquid can be discharged from the side ports defined by the ends of the channels G3 and G4.

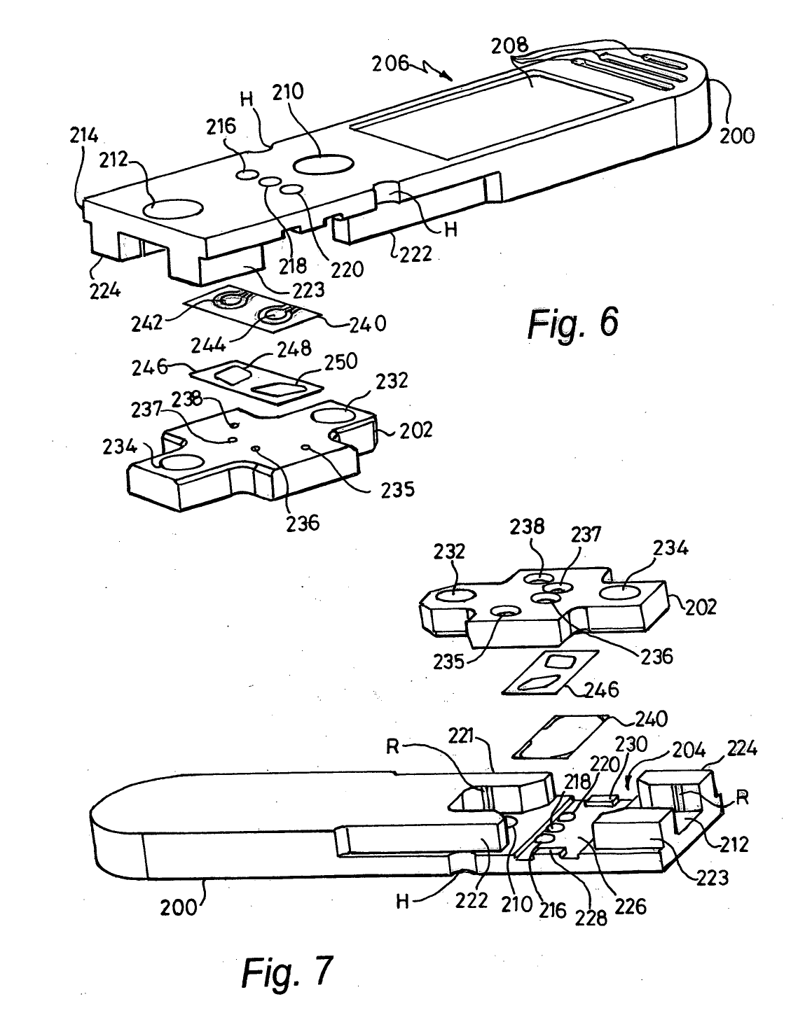

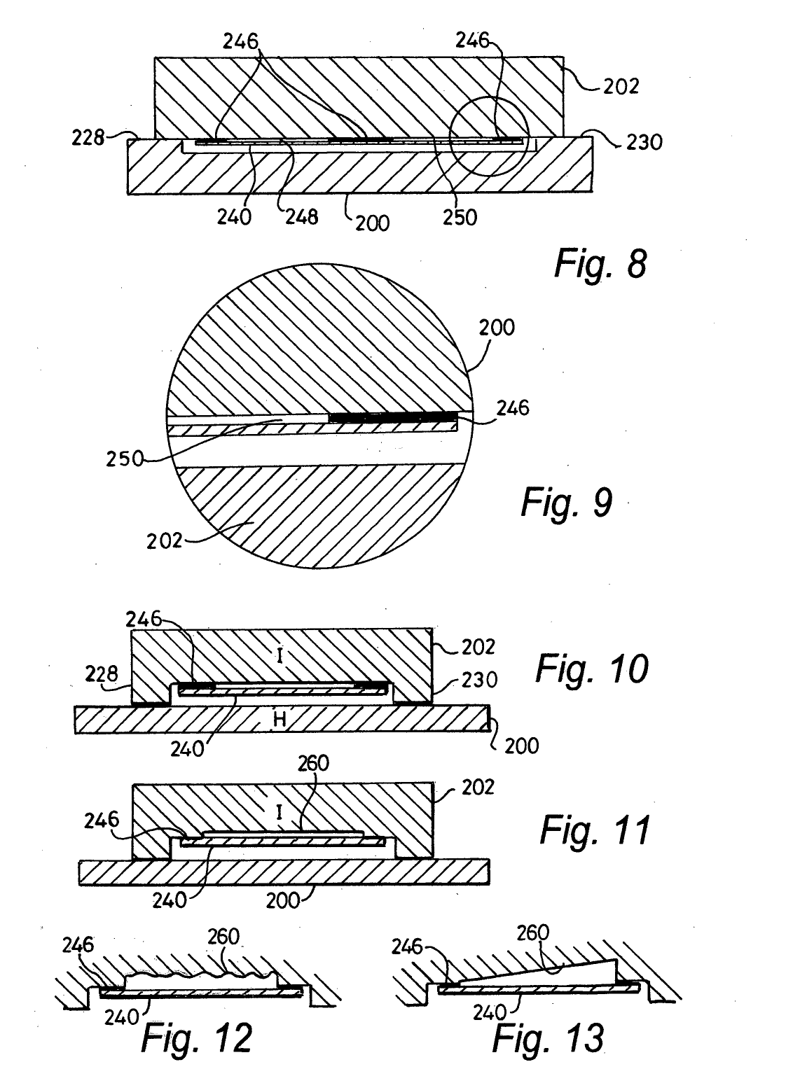

With reference to FIGS. 6 and 7, the third embodiment of cartridge has a housing which, in exterior shape, is similar to the housing of the first and second embodiments. In this case, however, the housing is formed from a first part 200 and a second part in the form of a cruciform insert 202 which is accommodated in a correspondingly shaped recess 204 in the first part 200.

The housing part 200 is an injection moulded component and may also be formed from a relatively compliant material such as Polypropylene or acrylic. This provides additional stress relief on insertion of the housing into the docking station and is particularly useful where the insert is rigid and provides most of the stiffness in the assembly as described below.

The housing part 200 has a solid body portion 206 which, in use, is grasped by a user inserting or removing the cartridge, and is situated in the trailing half of the cartridge, i.e. the half which remains protruding from the docking station after the cartridge has been inserted. The portion 200 includes a pattern of depressions 208 which help the user to grip the cartridge.

The part 200 includes two relatively large circular apertures 210 and 212 disposed on the longitudinal axis of the part, and in between the formations 208 and the front end (referenced 214) of the cartridge. Between the apertures 210 and 212 is situated a lateral row of smaller apertures 216, 218 and 220.

Each of the apertures 210 and 212 opens onto the underside of the part 200 at a position between a respective one of two pairs of longitudinally arranged spaced fingers 221-224, the fingers 221 and 222 being spaced from the fingers 223 and 224 so that the cruciform recess 204 is defined by these fingers.

The portion of the underside of the part 200 in the recess 204 between the two pairs of fingers includes a further recess 226 extending across the width of the part 200. The apertures 216, 218 and 220 open onto the recess 226, and the ends of the recess 226 are forked to define two opposed feet 228 and 230. The aperture 210 is situated between a pair of side notches H which assist in the location of the cartridge in a docking station.

The insert which constitutes the housing part 202 is fabricated from a more rigid material than the part 200. Example of suitable material include glass, silicon, high performance engineering plastics such as PEEK, ABS etc and other materials that can be machined or etched with a high precision. It is preferable that the material has a coefficient of thermal expansion close to or the same as that of quartz (e.g. glass) so that the insert does not exert any substantial tension or compression force on a quartz crystal resonator element mounted thereon as a result of changes in temperature during operation of the sensor.

The insert 202 forms part of a subassembly in which the upper surface of the insert (as viewed in FIG. 6) acts as a substrate for a sensor having two flow cells as described below.

At either end of the part 202 there are provided relatively large apertures 232 and 234, each of which, in the assembled cartridge, is aligned with a respective one of the apertures 212 and 210. In the portions of the insert 202 between those two apertures, there are provided four passages 235-238 extending through the part 202, and arranged to receive ferrules of the fluidic supply system of the docking station. As can be seen from FIGS. 6 and 7, the passages 235-238 have enlarged diameter outboard, i.e. lower, ends and taper to smaller diameter upper ends. Because of the rigidity of the member 202, the apertures 232 and 234 and passages 235-238 can be formed at precisely predetermined locations to ensure that, with the insert 202 correctly positioned in the docking station, the apertures and passages are correctly positioned relative to the co-operating elements of the station.

As is indicated above, the sensor comprises a transducer in the form of a quartz crystal plate 240 which is contained in the recess 204. The plate is coated on one surface with gold in a pattern that defines a pair of drive electrodes 242 and 244, each of which is in registry with a respective one of two separate flow cells. The underside of the plate is also coated with gold to form a common earth electrode. A conductive track (not shown) runs from this electrode around the edge of the plate to the top surface of the plate to provide a contact for enabling a coda pin engaging the top surface of the plate to connect to the earth electrode.

The plate 240 is adhered to the top (as viewed in FIG. 6) surface of an adhesive membrane 246 the underside of which is adhered to the upper surface of the insert 202. The upper surface of the insert 202 thus constitutes a support surface for the transducer plate 240.

The membrane 246 is a three layered structure of a total thickness of 85 microns, and comprising a polyester film carrier layer of 12 microns thickness sandwiched between two adhesive layers, each of a thickness of approximately 36.5 microns. An example of suitable material for the membrane is the double sided adhesive tape sold under the trademark FASTOUCH. The membrane 246 has two generally diamond shaped apertures 248 and 250.

Each of the apertures 248 and 250 is in registry with a respective electrode 242 and 244, and thus with an active area of the quartz crystal. The membrane 246 spaces the plate 240 from the upper surface of the insert 202 so that there is a small gap between each of two said active areas of the quartz crystal and the upper surface of the plate 202, each gap being bounded by the edge of a respective one of the two apertures 248 and 250. Each gap constitutes a respective flow cell which communicates with a respective pair of inlet/outlet passages 235-238 in the insert 202.

The inlet and outlet for each flow cell are located at opposite end regions of the latter. Consequently, a sample introduced into the inlet of the flow cell will flow along the length of the flow cell to the outlet, during which period the sample will interact with the active surface of the crystal and the effect of that interaction will be measured.

The plate 240 and membrane 246 lie across the widest portion of the insert 202, but stop short of the sides of the insert so that, in the assembled cartridge, the membrane and plate lie in the space in the recess 226 between the feet 228 and 230. Thus the membrane and plate do not make direct contact with the upper part 200 in the assembled cartridge.

The insert 202 can be fitted to the part 200 in a variety of ways, for example by hard bonding or gluing, press fitting or using crush ribs R on the fingers 221 and 224.

Additionally or alternatively, one or both housing parts may have latching formations which automatically retain the insert when the latter is pushed into the other housing part. In any case, when fitted in the other housing part, insert 202 abuts the feet 230 and 228 and the parts of the underside of the recess 204 either side of the recess 226 so that there are defined side openings in the cartridge on either side of the feet 228 and 230. The insert engages the upper part 200 in such a way that it is rigidly locked in position and the areas of the surface 237 outside the membrane are fully supported by the housing part 200.

As well as securing the plate 240 in position and defining each flow cell, the membrane 246 provides a suitable seal, by virtue of the adhesive layers, for preventing fluid escaping from the flow cells. Obtaining reliable production of liquid tight cells by this method is advantageous as is providing means for any leakage to drain away safely should it occur. The invention is particularly suitable for this. The adhesive attachment between membrane and plate and the membrane and housing part must be sufficiently strong to resist local delamination at one or other interface in the presence of liquids in the cell under this pressure. This can be achieved by providing a substantial width of adhesive membrane between the cell boundary and the edge of the plate, and by choosing an adhesive with high adhesion and cohesion. It has been found in practice that with narrower widths and/or weaker adhesive properties, the liquid in the cell causes defects in the adhesive layer to open up and his can cause leaks if the defects extend to the outer edge. This process may be accelerated where the fluid is pumped under pressure through the cell. Such leaks are damaging to the instrument and even at a low incidence rate are unacceptable.

It has been found that a minimum membrane width of ˜2 mm is sufficient to achieve a low level of leaks with the Fastouch adhesive tape. Tapes having higher adhesive strength may be utilised in order to reduce the membrane minimum width or to reduce the level of leaks further. Without being bound by any theory however it is believed that the chemical composition of the tape as well as its adhesive and cohesive properties is important in determining the resistance to leaks. As a result some tapes having high adhesion and cohesion may not all be equally suitable.

However any fluid that does leak into the recess 226 can escape through the openings on either side of the feet 228 and 230. In use, corresponding coda pins of the docking mechanism extend through apertures 216, 218 and 220 to make respective contact with the electrodes 242 and 244 and the earth contact of the plate 240. Notches H in the upper plate serve to provide an initial location of the cartridge in the docking mechanism.

The larger diameter apertures 210, 212, 232 and 234 define two large bore through passages in the cartridge housing (constituted by housing part 200 and insert 202). These passages, in use, accept lateral location pins (not shown) of the docking mechanism for assisting in the correct location of the cartridge. These pins also form part of a Faraday cage surrounding the transducer and connection pins.

After a cartridge has been inserted into the docking mechanism, the ferrules on the fluidic supply system are pressed into the passages 235-238 with sufficient force to cause the ferrules to deform and thereby create a fluid seal.

Then each of the coda pins is extended into a respective aperture 216, 218 and 220 to engage the drive electrode or, as the case may be the earth contact on the plate 240.

The apertures in the upper part 200 can be oversized in order to facilitate alignment with the corresponding portions of the docking station since the proper positioning of the sensor and fluid passages will be achieved purely by the location of the interaction between the location pins and the insert 202.

The cartridges shown in FIGS. 10 and 11 are identical in many respects to the embodiment of FIGS. 6 and 7, and corresponding components have therefore been denoted by the reference numerals used in FIGS. 6 and 7.

Thus, the first, upper housing part is denoted by reference numeral 200, whilst reference numeral 202 denotes the cruciform insert. The arrangement of FIG. 10 differs from the FIGS. 6 and 7 embodiment in three respects.

Firstly, the feet 228 and 230 are integrally formed with the insert 202 and are adhered to the housing part 200 in the recess 226 to define the side openings on either side of the feet 228 and 230. In addition, the membrane 246 has only one opening, and therefore defines only a single circular or lozenge shaped flow cell. Consequently, the quartz crystal plate 240 carries only one drive electrode and the numbers of apertures for connection to the coda pins and ferrules are reduced accordingly (i.e. there are two apertures for the coda pins and just a single pair of inlet/outlet apertures for fluidic connection).

The sensor shown in FIG. 11 differs from that shown in FIG. 6 in that the insert 202 carries a recess 260 (of a circular or lozenge shape) which meets the membrane 246 at its periphery so that the faces of the flow cell defined by the crystal 240 and the insert 202 are separated by the walls of the recess 260 and by the membrane 246. The recess 260 increases the capacity of the flow cell and enables more features to be accommodated therein. In addition, the use of the recess enables a thinner adhesive tape to be used to attach the crystal 240 to the insert 202.

FIGS. 12 and 13 show modifications to the insert 260 intended to reduce or eliminate any tendency for standing waves (so called longitudinal modes) to be set up in the sample in the flow cell as a result of reflections between the face of the recess 260 and the plate 240.

In FIG. 12 the face of the recess 260 opposite the plate 240 carries a series of dimples, whilst in FIG. 13 the height of the recess 260 progressively varies from one side to the other so as to define a tapered flow cell. The angle of inclination has been exaggerated for clarity. In practice the angle would be of the order of a few degrees depending on the frequency of operation of the transducer and the size of the flow cell.

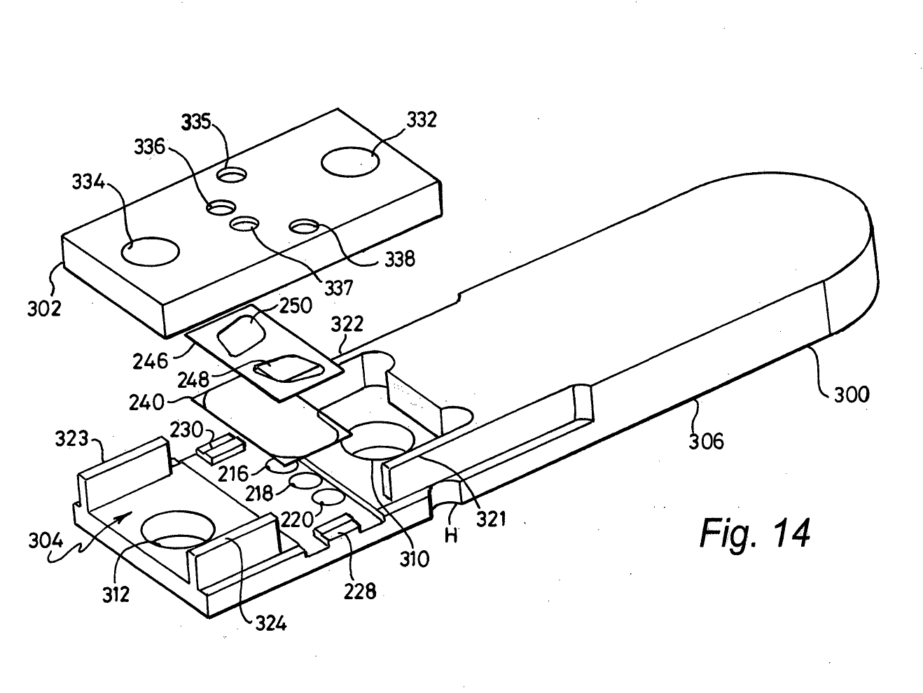

The cartridge shown in FIG. 14 has many features which are very similar to those of the third embodiment of cartridge, and these features are therefore denoted by the reference numerals used in FIGS. 6 and 7, raised by 100.

In this particular case, the insert 302 is rectangular, and the spacing and geometry of the fingers 321-324 are such as to enable the insert 302 to be accommodated in the housing part 300.

1. A cartridge for apparatus for analysing a sample comprising a fluid, the cartridge comprising a housing having at least two parts and a sample receiving cell comprising a surface, on one of said parts, a sensor comprising an electrical-mechanical transducer spaced from said surface, and an adhesive membrane attaching the sensor to one of the housing parts, wherein the membrane is attached only to one of said parts of the housing.

2. A cartridge according to claim 1, in which the surface of the housing defining part of the cell is on the housing part to which the sensor is attached, the surface being spaced from the sensor by said membrane.

3. A cartridge according to claim 2, in which the other housing part includes a recess in which the cell is situated.

4. A cartridge according to claim 3, in which the recess surrounds the cell.

5. A cartridge according to claim 4, in which the recess and surface define a cavity in which the membrane is wholly contained.

6. A cartridge according to claim 1 in which the housing parts engage each other in such a way as to locate the housing parts relative to each other so as to prevent relative shear movement of the parts along a first axis.

7. A cartridge according to claim 6, in which said engagement also prevents relative shear movement of the two housing parts along a second axis perpendicular to the first axis.

8. A cartridge according to claim 7, in which the housing parts interlock with each other.

9. A cartridge according to claim 7, in which one of the housing parts is attached to the other.

10. A cartridge according to claim 9, in which the housing parts are bonded together at areas spaced from the membrane.

11. A cartridge according to claim 10, in which the housing parts are bonded together by means of an adhesive.

12. A cartridge according to claim 11, in which the adhesive is rigid.

13. A cartridge according to claim 1, in which the housing part to which the sensor is attached is rigid has a Young's modulus of not less than 95 GPa.

14. A cartridge according to claim 1, in which each housing part comprises a respective plate.

15. A cartridge according to claim 1, in which the housing part having the surface constituting part of the cell, comprises a plate and is an insert for a recess in the other housing part, said insert being more rigid than said other housing part.

16. A cartridge according to claim 1, in which the cell is a flow cell and has a fluid inlet and a fluid outlet formed as apertures in the insert.

17. A cartridge according to claim 15, in which the insert is of a cruciform shape.

18. A cartridge according to claim 1, in which the sensor comprises a piezoelectric element.

19. A cartridge according to claim 1, in which the cartridge includes one or more drainage conduits, for any leak of fluid from the cell.

20. A cartridge according to claim 19, in which the one or more drainage conduits comprise channels or gullies in one of the housing parts.

21. A cartridge according to claim 1, in which the transducer has multiple sensing areas.

22. A cartridge according to claim 18, in which the transducer comprises a transverse shear mode piezoelectric resonator.

23. A cartridge according to claim 18, in which the transducer comprises a quartz crystal.

24. A cartridge according to claim 1, in which the housing parts contact each other in such a way that the other housing part provides one or more surfaces which support the housing part defining part of the cell, and extend in opposite directions along one axis from two opposing sides of the cavity, in such a way that the housing part defining part of the cell forms a fully supported beam.

25. A cartridge according to claim 7, in which said engagement also prevents relative movement of the parts, towards or away from each other, along a third axis perpendicular to the first and second axes.
